(19) United States
(12) Patent Application Publication
(10) Pub. No.: US 2025/0168839 A1
(43) Pub. Date: May 22, 2025

(54) BEAM SWEEP ADAPTATION IN A WIRELESS COMMUNICATION NETWORK

(71) Applicant: Telefonaktiebolaget LM Ericsson (publ), Stockholm (SE)

(72) Inventors: Andres Reial, HÖLLVIKEN (SE); Ilmiawan Shubhi, MALMÖ (SE); Muhammad Ali Kazmi, Reston, VA (US); Sina Maleki, MALMÖ (SE); Santhan Thangarasa, VÄLLINGBY (SE); Kazuyoshi Uesaka, KAWASAKI KANAGAWA (JP)

(21) Appl. No.: 18/834,999

(22) PCT Filed: Mar. 4, 2022
(86) PCT No.: PCT/EP2022/055574

§ 371 Date: Jul. 31, 2024

(51) Int. Cl. H04W 72/044

(52) U.S. Cl. CPC H04W 72/046

(57) ABSTRACT

A computer-implemented method performed by a wireless device in a wireless communication system is disclosed. The method comprises obtaining a beam timing variability parameter indicative of a change in receive (RX) timing for a reference signal associated with an RX beam. Then, if the beam timing variability parameter is above a threshold, the method comprises using an RX beam sweeping configuration in accordance with a first receiver activity pattern. Further, if the beam timing variability parameter is below the threshold, the method comprises using an RX beam sweeping configuration in accordance with a second receiver activity pattern.

### TECHNICAL FIELD

The present disclosure relates to the field of wireless communication networks, and in particular to beam sweep adaptation based on beam timing variability.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems.

A wireless device (WD) may establish a connection with a base station and communicate with the base station using beamformed transmissions. The WD may perform a beam sweep procedure to help detect and select a beam for establishing a connection with the base station. In some cases, conventional beam sweep procedures may be time consuming, resulting in long measurement delay and leading to high power consumption. There is therefore a need for improved methods for reducing WD beam sweeping to complete a beam sweep faster and/or to reduce the power consumption associated with beam monitoring and best beam pair tracking.

### SUMMARY

An object of the present disclosure is to provide a method performed by a wireless device (WD) in a wireless communication system for RX beam sweep adaptation/optimization based on beam timing variability, a non-transitory computer-readable storage medium, a wireless device, a method performed by a network node, a non-transitory computer-readable storage medium, and a network node, which alleviates all or at least some of the above-discussed drawbacks of presently known solutions.

This and other objects are achieved by means of a method performed by a wireless device (WD) in a wireless communication system for RX beam sweep adaptation/optimization based on beam timing variability, a non-transitory computer-readable storage medium, a wireless device, a method performed by a network node, a non-transitory computer-readable storage medium, and a network node as defined in the independent claims.

According to an aspect there is provided a computer-implemented method performed by a wireless device (WD) in a wireless communication system. The method comprises obtaining a beam timing variability parameter indicative of a change in receive (RX) timing for a reference signal (RS) associated with an RX beam. Then, if the beam timing variability parameter is above a threshold (H1), the method comprises using an RX beam sweeping configuration in accordance with a first receiver activity pattern. Further, if the beam timing variability parameter is below the threshold (H1), the method comprises using an RX beam sweeping configuration in accordance with a second receiver activity pattern.

Further, according to another aspect, there is provided a non-transitory computer-readable storage medium storing one or more programs configured to be executed by one or more processors of a wireless device, the one or more programs comprising instructions for performing the method according to any one of the embodiments disclosed herein. With this aspect of the disclosure, similar advantages and preferred features are present as in the previously discussed aspect of the disclosure.

Still further, according to another aspect, there is provided a wireless device for communicating with a network node in a wireless communication system. The wireless device comprises processing circuitry configured to obtain a beam timing variability parameter indicative of a change in receive (RX) timing for a reference signal (RS) associated with a beam. If the beam timing variability parameter is above a threshold (H1), the processing circuitry is configured to use an RX beam sweeping configuration in accordance with a first receiver activity pattern. Moreover, if the beam timing variability parameter is below the threshold (H1), the processing circuitry is configured to use an RX beam sweeping configuration in accordance with a second receiver activity pattern. With this aspect of the disclosure, similar advantages and preferred features are present as in the previously discussed aspect of the disclosure.

Yet further, in accordance with another aspect, there is provided a computer-implemented method performed by a network node for communicating with a wireless device (WD) in a wireless communication system. The method comprises determining a set of receive (RX) adaptation parameters indicative of a threshold (H1), where the set of RX adaptation parameters is to be used by a WD for determining a RX beam sweeping configuration. The method further comprises transmitting the determined set of RX adaptation parameters to the WD. With this aspect of the disclosure, similar advantages and preferred features are present as in the previously discussed aspect of the disclosure.

According to yet another aspect, there is provided a non-transitory computer-readable storage medium storing one or more programs configured to be executed by one or more processors of a network node, the one or more programs comprising instructions for performing the method according to anyone of the embodiments disclosed herein. With this aspect of the disclosure, similar advantages and preferred features are present as in the previously discussed aspect of the disclosure.

Still further, in accordance with another aspect, there is provided a network node for communicating with a wireless device (WD) in a wireless communication system. The network node comprises processing circuitry configured to determine a set of receive (RX) adaptation parameters indicative of a threshold (H1), where the set of RX adaptation parameters is to be used by a WD for determining a RX beam sweeping configuration. The processing circuitry is further configured to transmit the determined set of RX adaptation parameters to the WD. With this aspect of the disclosure, similar advantages and preferred features are present as in the previously discussed aspect of the disclosure.

Further embodiments of the disclosure are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

An advantage of some embodiments is that the beam sweeping activity time of the WD may be reduced to complete a beam sweep in a faster manner.

An advantage of some embodiments is that the beam tracking in dynamic environments may be improved.

An advantage of some embodiments is that the WD's energy consumption associated with beam monitoring and best beam pair tracking may be reduced.

These and other features and advantages of the present disclosure will in the following be further clarified with reference to the embodiments described hereinafter.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1a is a schematic illustration of an RX beam sweeping configuration with a first receiver activity pattern in accordance with some embodiments.

FIG. 1b is a schematic illustration of an RX beam sweeping configuration with a second receiver activity pattern in accordance with some embodiments.

FIG. 1c is a schematic illustration of an RX beam sweeping configuration with a first receiver activity pattern in accordance with some embodiments.

FIG. 2 is a schematic flow chart representation of a computer-implemented method performed by a wireless device (WD) in a wireless communication system in accordance with some embodiments.

FIG. 3 is a schematic flow chart representation of a computer-implemented method performed by a wireless device (WD) in a wireless communication system in accordance with some embodiments.

FIG. 4 is a schematic flow chart representation of a computer-implemented method performed by a network node for communicating with a WD in a wireless communication system in accordance with some embodiments.

FIG. 5 is a schematic illustration of a wireless communications network comprising a network node and a wireless device in accordance with some embodiments.

### DETAILED DESCRIPTION

Aspects of the present disclosure will be described more fully hereinafter with reference to the accompanying drawings. The control device and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not necessarily intended to limit the scope. As used herein, the singular forms “a”, “an” and “the” are intended to include the plural forms as well, unless the context clearly indicates otherwise.

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

It should be noted that although terminology from a specific telecom network system such as e.g. 3GPP 5G may be used herein to explain the example embodiments, this should not be seen as limiting the scope of the example embodiments to only the aforementioned system. Other telecom systems, including LTE, WCDMA, WiMax, UMB, GSM, 6G and evolutions in the underlying technologies or standards of the current framework may also benefit from the example embodiments disclosed herein.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

Transmitting in downlink may pertain to transmission from the network or network node to the terminal (e.g. wireless device). Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

The term “RX beam” and in particular with reference to the wording “pointing an RX beam” may be understood as “tuning the receiver to receive signals from a certain spatial direction”. Thus, an “RX beam sweep” can be construed as a “tuning of the receiver to receive signals from one or more spatial directions”. However, the terms “RX”, “TX”, “beam”, “sweep”, and so forth are considered to be readily understood by the skilled person in the art, and will for the sake of brevity and conciseness not be further elaborated upon herein.

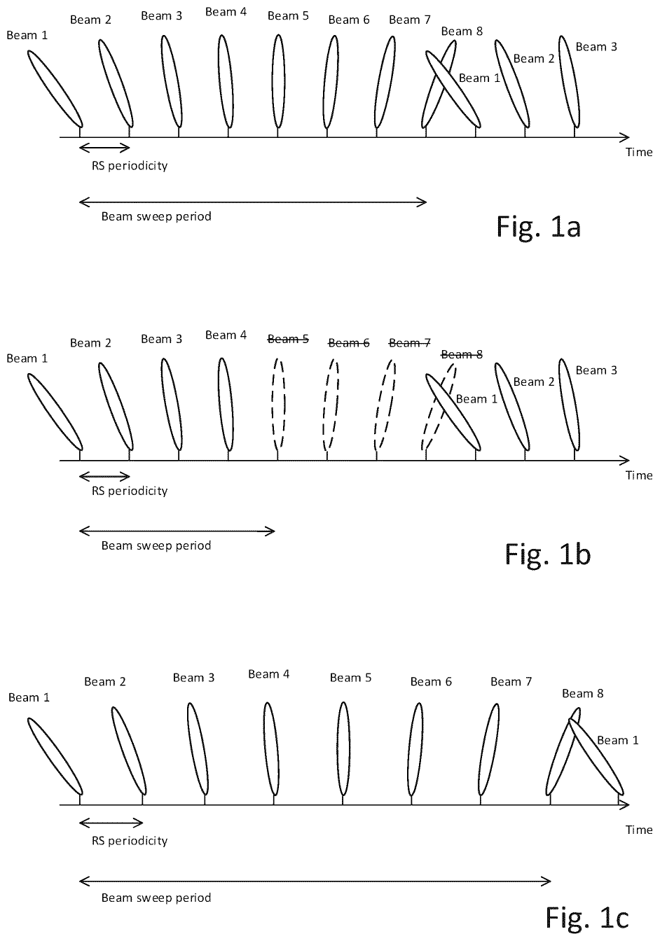

FIGS. 1a-c are three schematic illustrations of different cases for RX beam sweeping in accordance with some embodiments. FIG. 1a shows a “baseline” RX beam sweep, may be referred to as a legacy beam sweep in the following, where the wireless device (WD) steps through multiple RX beam configurations (N_{RX}=8 in the depicted example). The baseline RX beam sweep typically spans a set of spatial directions that make up approximately omnidirectional coverage.

In accordance with some embodiments herein, the WD is configured to adapt the RX beam sweeping based on a beam timing variability, as will be elaborated upon in the following. In short, the WD is configured to use an RX beam sweeping configuration in accordance with a first receiver activity pattern (e.g. as illustrated in FIG. 1a), or a second receiver activity pattern (e.g. as illustrated in FIGS. 1b or 1c) based on a relationship between a beam timing variability parameter and a threshold (H1). Accordingly, the WD may reduce the number of RX beams to monitor and only sweep a subset of all of the available RX beams in a beam measurement period (FIG. 1b). Alternatively, or additionally, the WD may sweep all of the available RX beams of the beam sweep period, but instead extend the beam sweep period in order to obtain more opportunities to provide some additional sleep opportunities, e.g. longer sleep durations. It should be noted that the depicted example of FIG. 1b where the WD only sweeps the first four beams (i.e. Beam 1-4) is merely an example out of several possible configurations. For example, in some embodiments, the UE sweeps only the first RX beam of a beam sweep period, only two consecutive RX beams of a beam sweep period, or only the four last RX beams of a beam sweep period, and so forth. This, as well as other example configurations of the second receiver activity pattern will be further elaborated upon in the following.

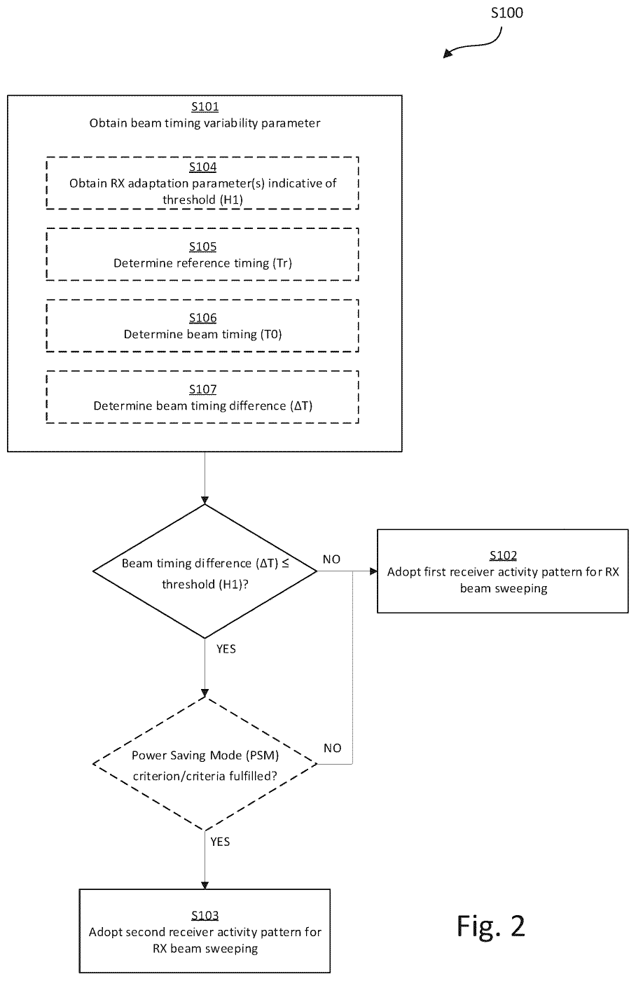

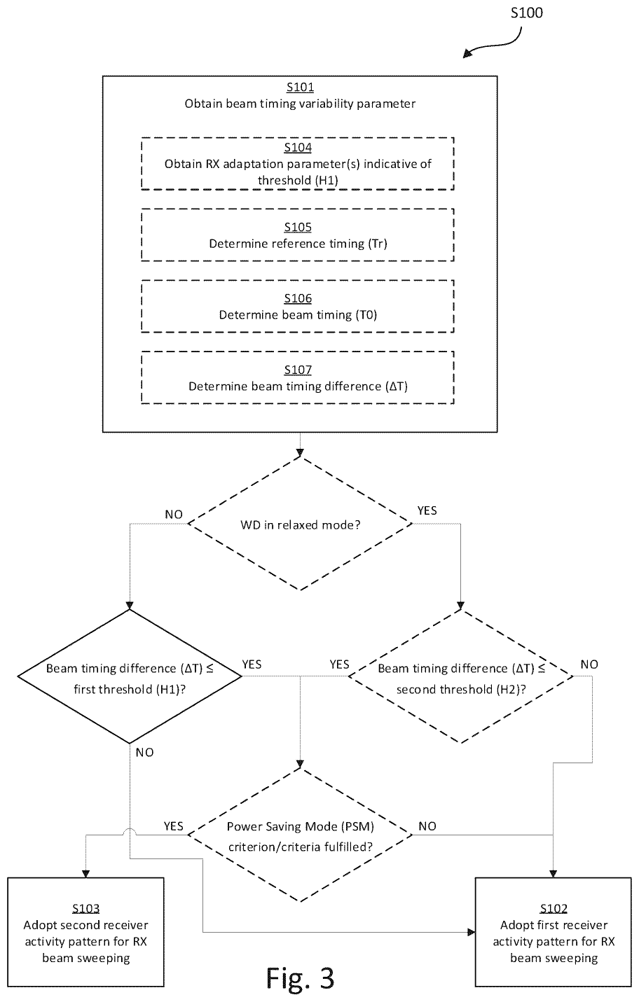

FIGS. 2 and 3 are schematic flowchart representations of a method S100 performed by a wireless device (WD) in a wireless communication system in accordance with some embodiments. In particular, the method S100 is suitable for RX beam sweep adaptation/optimization based on beam timing variability. The method S100 comprises obtaining S101 one or more beam timing variability parameters indicative of a change in RX timing for a reference signal (RS) associated with an RX beam. The term obtaining is herein to be interpreted broadly and encompasses receiving, retrieving, collecting, acquiring, configuring, determining, estimating, and so forth. The beam timing variability parameter may be construed as a parameter characterizing/defining a change or a rate of change in RX timing for a RS associated with an RX beam.

A reference signal (RS) may in accordance with some embodiments be a physical signal, such as the following non-exhaustive list of suitable signals: a Primary Synchronization Signal (PSS), a Secondary Synchronization Signal (SSS), a Channel State Information Reference Signal (CSI-RS), a Demodulation Reference Signal (DMRS), a Discovery Reference Signal (DRS), a signal in Synchronization signal and Physical Broadcast Channel (PBCH) block, a Cell-Specific Reference Signals (CRS), or a Positioning Reference Signals (PRS). The RS may be periodic, for example, an RS occasion carrying one or more reference signals may occur with certain periodicity such as e.g. every 20 ms, 40 ms and so forth. However, in some embodiments, the RS is aperiodic.

In general, each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE may accordingly be configured with information about SSB on cells of a certain carrier frequency by one or more SS/PBCH block measurement timing configurations (SMTCs). The SMTC comprises parameters such as SMTC periodicity, SMTC occasion length in time or duration, SMTC time offset with respect to a reference time (e.g. the serving cell's System Frame Number, SFN) etc. Therefore, SMTC occasions may also occur with certain periodicity e.g. 5 ms, 10 ms, 20 ms, 40 ms, 80 ms and 160 ms.

Moreover, the beamformed transmission of the DL reference signal (RS) (e.g. SSB, CSI-RS) may interchangeably be called a DL beam, RX beam, spatial filter, spatial domain transmission filter, main lobe of the radiation pattern of antenna array, etc. The RS or beams may be addressed, referred to, or configured by an identifier, which can indicate the location of the beam in time in beam pattern e.g. beam index such as SSB index indicate SSB beam location in the pre-defined SSB format/pattern

In some embodiments, the beam timing variability parameter(s) comprises a beam timing difference (ΔT). In more detail, in some embodiments, the step of obtaining S101 the one or more beam timing variability parameters comprises obtaining S104 a set of RX adaptation parameters indicative of a threshold (H1), determining S105 a reference timing (Tr) of the reference signal to be received by the WD, determining S106 a beam timing (T0) of the reference signal received by the WD, and determining S107 a beam timing difference (ΔT) indicative of a difference between the determined reference timing and the determined beam timing. A “set” is in the present context to be construed as a gathering or collection of one or more elements or objects, i.e. a set of parameters may be understood as one or more parameters.

The RX adaptation parameters may be predefined. In more detail, RX adaptation parameters may be predefined or predetermined for different operating scenarios (depending on cell types, ongoing traffic arrival patterns or service types, mobility patterns, etc.) by the WD. Alternatively, the RX adaptation parameters may be configured by the network node, and transmitted to the WD e.g. via dedicated Radio Resource Control (RRC) signaling or via System Information (SI) broadcast.

Further, the method S100 comprises using S102 an RX beam sweeping configuration in accordance with a first receiver activity pattern if the beam timing variability parameter is above the threshold (H1). Accordingly, if the beam timing variability parameter is below (or equal to) the threshold (H1), the method S100 further comprises using S103 an RX beam sweeping configuration in accordance with a second receiver activity pattern.

In some embodiments, the RX beam sweeping configuration in accordance with the first receiver activity pattern comprises a legacy beam sweeping and measurement pattern for RS detection and measurements, while the RX beam sweeping configuration in accordance with the second receiver activity pattern comprises a more relaxed beam sweeping and measurement pattern for RS detection and measurements as compared to the first receiver activity pattern. The term “more relaxed” may refer to shorter measurement durations, lower measurement duty cycle, longer measurement period, etc.

Accordingly, the WD adapts its beam sweep in a cell based on observed changes in RX beam timing, where no or low variability (below threshold) of the beam timing is used as an indication that a full measurement schedule is unnecessary, and that a more “relaxed” or “lenient” measurement schedule can be adopted.

The WD estimates a timing change of a currently received reference signal (RS) transmission with respect to a timing reference, and adapts its RX beam sweeping procedure accordingly (i.e. based on whether the estimated timing change in beam timing exceeds a threshold). If the change exceeds a threshold, the UE may adopt/utilize a full beam sweep or increase the sweep rate. However, if it is below (or equal to) the threshold, the UE may fully or partially omit beam sweeping for some time interval, reduce the sweeping rate, or the number of RX beams to be swept. The threshold is preferably chosen low enough so as to avoid or at least minimize any performance impact.

Hereby the energy consumption of the wireless device may be reduced with little-to-no negative impact on the performance (adequate beam tracking in dynamic environments is still achievable).

Moving on, in some embodiments, the reference timing (Tr) is determined S105 based on an arrival timing of one or more previous reference signals at the wireless device, and the beam timing (T0) is determined S106 based on an arrival timing of a current reference signal at the wireless device. Accordingly, the determined reference timing (Tr) may be defined as an expected time of arrival of the reference signal to be received by the WD (i.e. the expected time of arrival at the current RS instance), while the beam timing (T0) is the actual arrival timing of the reference signal (i.e. current RS instance).

Thus, in some embodiments, the step of determining S105 a reference timing (Tr) further comprises determining an arrival time of one or more reference signals previously received by the WD, and determining the reference timing (Tr) of the reference signal to be received by the WD based on the determined arrival time of the one or more reference signals previously received by the WD. The RS used for determining the Tr and T0 parameters may, but need not be, the same RS type.

In more detail, the arrival instant (arrival timing) at one or more previous reference signal occasions for a beam may be used as a timing base, based on e.g. PSS correlator peak timing. A reference time (Tr) may then be obtained/determined by for example adding the measurement period value to the previous timing base. Moreover, in some embodiments, the determining the arrival time comprises determining a frame start time, and the determining S105 of a reference timing (Tr) comprises adding a frame boundary-to-reference signal time delay to the determined frame start time

The reference timing (Tr) value may as mentioned be based on multiple previous RS detection/receive timings, e.g. averaged or otherwise filtered or smoothed estimate, where the estimation may be performed according to approaches known in the art.

Regardless of the approach used for determining S105 the reference timing (Tr) and the beam timing (T0), the values are estimated and stored in the WD in order to determine a beam timing difference, i.e. an offset, (ΔT) of the beam timing (T0) with respect to the reference time (Tr). In other words, ΔT=|T0−Tr|.

The reference time (Tr) and beam timing (T0) may for example be in the form of a frame, slot, or symbol start time, or any other suitable network timing reference known to the WD. The receive time offset or offset value (ΔT), which is the magnitude of difference between T0 and Tr, is then compared to the threshold (H1) as indicated in the flowchart of FIG. 2, in order to determine if the WD is to adopt S102 the first receiver activity pattern or to adopt S103 the second receiver activity pattern.

Furthermore, the arrival time or receive time of a reference signal may be estimated based on the first detected path of a beam, provided its signal level is above certain threshold. Thus, in some embodiments, the determined arrival time of the one or more reference signals previously received by the WD is an arrival time of one or more reference signals of a first beam of a beam measurement period. Accordingly, the determined beam timing (T0) of the reference signal received by the WD is the arrival time of one or more reference signals of a currently received first beam of the beam measurement period. Thus, the beam timing difference (ΔT) may be determined based on the first reference signal received in the first beam of the beam sweep period and not the other ones, and perform the subsequent steps of the method S100. The advantage such embodiments is that the WD has the possibility to go to a “relax mode” for the rest of the beam sweep period if the relaxing conditions are satisfied, thereby further reducing the energy consumption of the WD. Alternatively, instead of the first beam the current strongest beam may be used.

Furthermore, the beam timing difference (ΔT) need not necessarily be determined S107 based on the first, second or following beams in a beam sweep period, if the corresponding signal level is not good enough, e.g., if the Reference Signal Received Power (RSRP) of the reference signal received in the first beam is below a specific threshold, e.g., −100 dBm, then, one can move to the other beams to determine S107 the beam timing difference (ΔT). The beam timing difference (ΔT) may for example be determined based on the strongest beam (i.e. beam containing the “strongest” signal according to a signal level metric) in a beam sweep period.

Thus, in some embodiments, the determined arrival time of the one or more reference signals previously received by the WD is one or more reference signals of previously received beam(s), of one or more previous beam sweep periods, having a signal level metric above a signal level threshold. Accordingly, the determined beam timing (T0) of the reference signal received by the WD is the arrival time of one or more reference signals of a currently received corresponding beam of a current beam sweep period. Thus, if the reference timing (Tr) is determined based on the third beam in a beam sweep period (e.g. due to the reference signal in that beam having the highest signal level metric, e.g. the highest RSRP of all of the beams in that beam sweep period), then the beam timing (T0) is determined based on the reference signal in the third beam in the current beam sweep period.

Moving on to the RX beam sweeping configurations, the method S100 comprises adopting S102 a first receiver activity pattern if the beam timing variability parameter exceeds the threshold (H1). In some embodiments, the method S100 comprises adopting S102 a first receiver activity pattern if the beam timing difference (ΔT) exceeds the threshold (H1). This may as mentioned be construed as a “non-relaxed” beam sweeping and measurement pattern (or less relaxed as compared to the second receiver activity pattern). The first receiver activity pattern may also be referred to as “regular” beam sweeping or legacy beam sweeping.

In some embodiments, the RX beam sweeping configuration in accordance with the first receiver activity pattern comprises sweeping all of the available RX beams in a beam measurement period (beam sweep period). Thus, if there are 8 RX beams in a beam sweep period, then the WD sweeps 8 RX beams in accordance with the first receiver activity pattern.

In some embodiments, the RX beam sweeping configuration in accordance with the first receiver activity pattern comprises beam sweeping at a higher rate as compared to the second receiver activity pattern. For example, the first receiver activity pattern may comprise sweeping once every T_{RS}, where T_{RS}=T_{SSB}, T_{RS}=T_{CSI-RS}, or T_{RS}=T_{PRS}. However, in some embodiments, the first receiver activity pattern may comprise sweeping once every T_{DRX}. Furthermore, in some embodiments, the first receiver activity pattern may comprise sweeping once every f(T_{RS}, T_{DRX}), where f( ) is a predefined function. Examples of suitable functions are maximum, minimum, median, x:th percentile, product, sum etc. Thus, in some embodiments, the first receiver activity pattern may comprise sweeping once every max(T_{RS}, T_{DRX}).

The Tᵢ variables mentioned in the foregoing define periodicities for various reference signals. In more detail, T_{RS}=periodicity of RS transmission, T_{SSB}=periodicity of SSB transmission, T_{CSI-RS}=periodicity of CSI-RS transmission, T_{PRS}=periodicity of PRS resource transmission, and T_{DRX}=DRX cycle length.

As mentioned in the foregoing, if the beam timing variability parameter, e.g. beam timing difference (ΔT), exceeds the threshold (H1), one can conclude that a full measurement schedule may be necessary due to the WD being exposed to unstable measurement conditions. In more detail, the exceeding of threshold may indicate that the WD has moved or that additional reflections have occurred since the beam is no longer received spatially directly by the WD. Therefore, in order to remain robust in changing channel conditions, the WD is configured to perform denser beam sweeping. However, on the other hand, if the beam timing variability does not exceed the threshold (H1) this is used as an indication that the channel conditions are more stable and that a full measurement schedule is unnecessary, i.e. the RX beam sweeping can be done in a more “relaxed” manner without impairing performance.

Further, in the scenario where the beam timing variability parameter, e.g. beam timing difference (ΔT), does not change or at least changes less than a certain threshold, i.e. ΔT<H1, the UE adopts S103 the more “relaxed” second receiver activity pattern for RX beam sweeping. The second receiver activity pattern may for example comprise sweeping one RX beam per time period (T₁), where T₁ may be 160 ms, 640, ms, and so forth. In the following a number of example embodiments will be provided in relation to the more “relaxed” receiver activity pattern, i.e. for the second receiver activity pattern for RX beam sweeping.

In some embodiments, the RX beam sweeping configuration in accordance with the second receiver activity pattern comprises pausing any RX beam sweeping for a predetermined amount of time (Tₚ). In other words, in some embodiments, the WD does not perform any RX beam sweeping for a predetermined amount of time and then resumes the RX beam sweeping after the predetermined amount of time. The pausing period (Tₚ) may for example be several hundred milliseconds or longer.

Moreover, in some embodiments, the RX beam sweeping configuration in accordance with the second receiver activity pattern comprises sweeping a subset of all of the available RX beams in a beam measurement period. In other words, the WD does not perform “full” RX beam sweeping but does a limited RX beam sweeping instead. For example, the WD UE may sweep only 2-4 RX beams instead of all 8 RX beams, assuming that there are 8 RX beams available in the beam sweep period. In other words, the second receiver activity pattern may comprise an RX beam sweep configuration as illustrated in FIG. 1B.

Moreover, in some embodiments, the number of RX beams in the subset is dependent on a difference between the beam timing variability parameter and the threshold (H1). In other words, the determination of the number of RX beams that the WD will sweep (in accordance with the second receiver activity pattern) may be based on the value of beam timing variability parameter (e.g. the value of ΔT). In more detail, the WD will sweep a smaller number of RX beams when the value of ΔT is smaller. For example, if

$$( \frac{H 1}{2} ) < Δ T \leq H 1 ,$$

then the WD will sweep 4 RX beams. If the value of ΔT is even smaller, e.g., if

$$Δ T < \frac{H 1}{2} ,$$

then the WD will sweep 2 Rx beams and so on. Alternatively, the relationship between beam timing variability parameter (e.g. ΔT) and the number of beams may be predetermined in a look-up table, or similar.

In some embodiments, the RX beams comprised in the subset is/are dynamically determined based on a measured signal level metric of the reference signals measured in the RX beams in a previous beam measurement period (beam sweep period). The term signal level metric is in the present context to be interpreted broadly and encompasses various metrics or parameters characterizing the strength or quality of a signal.

In more detail, the determination of which RX beam that will be swept by the WD may be based on the signal level (e.g. signal strength, signal quality, etc.) of the RX beams. Thus, the adopting S103 of the second receiver activity pattern may comprise selecting a subset of RX beams with the highest signal level metric (in a beam measurement period). In some embodiments the signal quality metric comprises a signal strength such as e.g., Reference Signal Received Power (RSRP), path loss, etc. In some embodiments, the signal quality metric comprises a signal quality such as e.g., Reference Signal Received Quality (RSRQ), Signal to Noise Ratio (SNR), Signal to Interference & Noise Ratio (SINR), and so forth.

In some embodiments, the RX beam which had previously largest signal level (e.g. signal strength) is swept first. In other words, if the second beam in a previous beam measurement period had the largest signal level, then the second beam of the current beam measurement period is swept first in order to establish the beam timing difference. Moreover, the UE may additionally sweep the RX beams that are spatially adjacent to the RX beam associated with the largest signal level. In some embodiments, the adopting S103 of the second receiver activity pattern may comprise selecting a subset of RX beams based on the duration over which certain RX beams have not been swept by the UE. For example the WD may sweep the RX beams which have not been swept for more than predefined time period. In other words, if RX beams 3 and 5 have not been swept during the last 5 seconds (assuming there are at least five beams in the beam sweep period), then the WD may include beams 3 and 5 in the subset for the next RX beam sweep.

Similar criteria, depending on e.g. ΔT in relation to H1 or the signal level, may be applied to determining the number of TX beams to measure in the TX beam sweep, or which TX beams to measure and in which order. More specifically, the UE may select to, while measuring with an RX beam during the RX beam sweep, limit the number of TX beams it measures. This may comprise e.g. only collecting received samples and performing reception processing for a subset of TX beam transmission instances (e.g. SSB instances in an SSB burst) in time and transitioning to a lower-power-state, e.g. micro-sleep or light sleep, during other TX beam transmission instances.

Further, in some embodiments, the RX beam sweeping configuration in accordance with the second receiver activity pattern comprises sweeping one or more of the current “best” RX beams more often, and sweeping the currently “weaker” beams less frequently. The definitions of the “best” and “weaker” RX beams may for example be based on the signal level metric of the reference signal of the RX beam (e.g. in reference to a signal level threshold, or in reference to each other). In more detail, the number of the RX beams in the (more frequently) monitored group can be fixed. For example, the first group (i.e. the more frequently monitored group) may contain the 2 “best” RX beams, while the second group (i.e. the less frequently monitored group), may contain 6 RX “weakest” beams (assuming there are at least RX beams available).

As mentioned, the “best” RX beams may be determined based on the signal level of the RS of the beam. For example the RX beam with largest signal level among all of the RX beams in the beam sweep period is considered as the “best” or “strongest” RX beam. Moreover, the number of RX beams inside a group can vary based on a certain threshold. For example, the first group may contain the RX beams associated with reference signals that have a signal level metric (e.g. signal strength, signal quality, etc.) equal to or above a certain threshold (e.g., P₁). Similarly, the RX beams associated with reference signals that have a signal level metric (e.g. signal strength, signal quality, etc.) below a certain threshold (e.g., P₂), will then be included in the second group. It should be noted that the classification of more frequent sweeping and less frequent sweeping may be extended to include more than two (beam) groups. In some embodiments, three (beam) groups may be used, i.e., a first, a second, and a third (beam) group, where the frequency of the beam sweeping of those groups are different. For example, the RX beams included in the first group, the second group, and the third group are swept in every k1, k2, and k3 times the RS transmission periodicity (T_{RS}) where k1>k2>k3. Here, k1, k2, and k3 may be predefined/predetermined positive integers, and T_{RS} may for example be a periodicity of an SSB transmission, a periodicity of CSI-RS transmission, or a periodicity of a PRS transmission.

As mentioned above, in some embodiments, the RX beam sweeping configuration in accordance with the second receiver activity pattern comprises sweeping a subset of all of the available RX beams of a beam measurement period. In other words, the RX beam sweeping configuration in accordance with the second receiver activity pattern causes the UE to reduce the number of RX beams (e.g. SSB beams) that are swept for the RS transmission (e.g. SSB burst), as compared to the first receiver activity pattern. Reducing the number of RX beams that are swept may reduce the energy consumption of the WD since the WD is allowed to e.g. omit entire SSB bursts and thereby reduce its continuous awake time (time out of deep sleep). Omitting some RX RS beams (e.g. SSB beams) that previously have resulted in low measurements and monitoring only a subset of RX RS beams (e.g. SSB beams), the WD may be configured to go into micro-sleep during the non-monitored RX beams in the sweep, or to spend more time in light or even deep sleep between bursts if the RS beams (e.g. SSB beams) that need to be monitored in a given burst are contiguous (next or together in sequence) in time resources (e.g. symbols, slots, etc.) or transmitted very frequently e.g. every 2nd slot.

In some embodiments, the RX beam sweeping configuration in accordance with the second receiver activity pattern comprises all of the available RX beams in a longer beam measurement period as compared to the beam measurement period used in the RX beam sweeping configuration in accordance with the first receiver activity pattern. In other words, the second receiver activity pattern may comprise an RX beam sweep configuration as illustrated in FIG. 1C.

In some embodiments, the RX beam sweeping configuration in accordance with the second receiver activity pattern comprises sweeping each RX beam in a beam measurement period every time instance defined by a first predefined function f₁(L₁, T_{RS}), where L₁ is a parameter relating the sweeping period to reference signal availability and T_{RS} is a periodicity of the reference signal transmission. Examples of suitable functions f₁( ) are maximum, minimum, median, xth percentile, product, sum etc. In one example embodiment, f₁(L₁, T_{RS})=L₁*T_{RS}. Moreover, T_{RS} may for example be a periodicity of an SSB transmission, a periodicity of CSI-RS transmission, or a periodicity of a PRS transmission. L₁ may be understood as a parameter that allows an expression of the sweeping period in terms of the RS availability period, e.g. every L₁:th occasion, or equal to RS period but at least/not more than L₁ ms, etc.

In some embodiments, the RX beam sweeping configuration in accordance with the second receiver activity pattern comprises sweeping each RX beam in a beam measurement period every time instance defined by a second predefined function f₂(L₂, T_{DRX}), where L₂ is a parameter relating the sweeping period to a DRX period and T_{DRX} is a DRX cycle length. Examples of suitable functions f₂( ) are maximum, minimum, median, xth percentile, product, sum etc. In one example embodiment, f₂(L₂, T_{DRX})=L₂*T_{DRX}. L₂ may be understood as a parameter that allows an expression of the sweeping period in terms of the DRX availability period, e.g. every L₂:th occasion, or equal to DRX period but at least/not more than L₂ ms, etc.

In some embodiments, the RX beam sweeping configuration in accordance with the second receiver activity pattern comprises sweeping each RX beam in a beam measurement period every time instance defined by a third predefined function f₃(L₁, T_{RS}, L₂, T_{DRX}), where L₁ is a parameter relating the sweeping period to reference signal availability, T_{RS} is a periodicity of the reference signal transmission, L₂ is a parameter relating the sweeping period to a DRX period, and T_{DRX} is a DRX cycle length. Examples of suitable functions f₃( ) are maximum, minimum, median, xth percentile, product, sum etc. In one example embodiment, f₃(L₁, T_{RS}, L₂, T_{DRX})=max(L₁*T_{RS}, L₂*T_{DRX}).

The various parameters L₁, L₂, T₁, and Tₚ mentioned in the foregoing may depend on the obtained S101 beam timing variability parameter or on the determined S107 beam timing difference (ΔT), e.g. the parameters L₁, L₂, T₁, and Tₚ may depend on the magnitude of the determined S107 beam timing difference (ΔT). In some embodiments, the parameters L₁, L₂, T₁, and Tₚ may depend on the relationship (e.g. difference) between the on the determined S107 beam timing difference (ΔT) and the threshold value (H1), or on the relationship (e.g. difference) between the on the obtained S101 beam timing variability parameter and the threshold value (H1). Moreover, in some embodiments, the parameters L₁, L₂, T₁, and Tₚ may depend on other criteria such as WD power/battery level (i.e. the urgency of energy saving). The parameters L₁, L₂, T₁, and Tₚ may be predetermined in a look-up table, or similar (including their different values in relation to other parameters (e.g. ΔT) and their relationships as exemplified).

In the example embodiments above, the RX beam sweeping is relaxed for the WD by adopting S103 the second receiver activity pattern. As mentioned, one can choose the RX beams that the WD should sweep, therefore in some embodiments, the RX beam sweeping configuration in accordance with the second receiver activity pattern comprises only sweeping the RX beams that are associated with relevant control resource set (CORESETs). In other words, only sweeping the RX beams where the WD is configured to expect to receive a PDCCH. For example, the WD may be configured to monitor PDCCH in a first CORESET, a second CORESET and a third CORESET, which in turn are configured to be associated with a first RX beam, a second RX beam and a third RX beam (or so called TC state). Thus, when relaxing the beam sweeping (i.e. adopting S103 the second receiver activity pattern), the WD may be configured to continue sweeping the RX beams associated with the beams configured for the CORESETs, or a subset of them. In reference to the latter, the WD may be configured to only sweep the first and second RX beams and not the third one, if the signal level metric (e.g. signal strength, signal quality, etc.) of the third one is below the aforementioned discussed threshold.

These embodiments are particularly advantageous when the WD is also expected to receive the physical downlink shared channel (PDSCH) in the same beam as it receives the PDCCH. As such, the WD typically does not expect to receive “useful” data in other beams which are not associated with the three CORESETs. Therefore, it is advantageous that the WD generally sweeps the RX beams associated with the three CORESETs, as exemplified above. Furthermore, if the WD is configured with the configuration where the UE expects to be indicated within the scheduling PDCCH of the RX beams where the PDSCH is expected to be received, the WD may additionally configured to consider the additional RX beams for sweeping even if they are not associated with the three CORESETs but activated by a MAC CE command.

Further, the adopting S103 of the second receiver pattern may be preceded by another check for condition fulfillment. Thus, in some embodiments, the using S103 an RX beam sweeping configuration in accordance with the second receiver activity pattern may be further conditioned on the WD fulfilling one or more criteria for one or more Power Saving Modes (PSMs). Moreover, in some embodiments, the using S103 an RX beam sweeping configuration in accordance with the second receiver activity pattern may be further conditioned on the signal level metric of the “best” beam (as defined above) being above a threshold value.

Examples of PSMs include one or more of low mobility, not-at-cell edge, and similar. The low mobility fulfilment may for example be based on the movement speed of the WD being below a threshold and/or on the Doppler frequency being below a threshold. This may for example be determined based on changes in measurement signal level (e.g. RSRP) over a certain time period e.g. WD meets the low mobility criterion if change in measured signal over the time period is below a threshold, otherwise it is not in low mobility. Similarly, the not-at-cell edge criterion may be considered fulfilled if the measured signal level is above certain threshold, otherwise the UE is at the cell edge. The UE may also be configured to operate in specific type of PSM e.g. in low mobility.

Accordingly, in some embodiments, the method S100 comprises using S103 an RX beam sweeping configuration in accordance with a second receiver activity pattern if the beam timing difference (ΔT) is below or equal to the threshold (H1) and the WD meets the criterion for at least one PSM (e.g. low-mobility criterion). However, if the above-mentioned conditions are not met, then the method S100 comprises using S102 an RX beam sweeping configuration in accordance with the first receiver activity pattern.

Similarly, in some embodiments, the method S100 comprises using S103 an RX beam sweeping configuration in accordance with a second receiver activity pattern if the beam timing difference (ΔT) is below or equal to the threshold (H1) and the signal level metric of the best beam is above a threshold (e.g. signal level metric may be a signal strength and the threshold may be X dB). However, if the above-mentioned conditions are not met, then the method S100 comprises using S102 an RX beam sweeping configuration in accordance with the first receiver activity pattern.

Similarly, in some embodiments, the method S100 comprises using S103 an RX beam sweeping configuration in accordance with a second receiver activity pattern if the beam timing difference (ΔT) is below or equal to the threshold (H1), the WD meets the criterion for at least one PSM (e.g. low-mobility criterion), and the signal level metric of the best beam is above a threshold (e.g. signal level metric may be a signal strength and the threshold may be X dB). However, if the above-mentioned conditions are not met, then the method S100 comprises using S102 an RX beam sweeping configuration in accordance with the first receiver activity pattern.

In the embodiments disclosed herein, the WD performs one or more measurements based on adapted RX beam sweeping (i.e. in accordance with the first or second receiver activity pattern), and the UE may further use the measurement results for one or more procedures or operational tasks. Examples of operational tasks are cell change, positioning, reporting measurement results to a network node etc. Examples of cell change are cell reselection, handover, RRC connection release with redirection, RRC connection re-establishment etc.

Furthermore, in some embodiments, the threshold (H1) comprised in the obtained S104 RX adaptation parameters may be a first threshold (H1), and the obtained S104 RX adaptation parameters may be further indicative of a second threshold (H2). Thereby, different thresholds (H1, H2) may be used for the comparison with the beam timing variability parameter (e.g. beam timing difference ΔT) depending on if the WD is in a “non-relaxed” mode or “relaxed” mode, i.e. if the most recently used RX beam sweeping configuration was in accordance with the first receiver activity pattern or second receiver activity pattern, respectively. For example, a higher threshold, i.e. the second threshold (H2), may be used when the WD is in the relaxed mode, while a lower threshold, i.e. the first threshold (H1) may be used when the WD is in the conventional, non-relaxed mode. An example of an embodiment employing such two thresholds, H1 and H2, where H1<H2, is illustrated in FIG. 3. Moreover, such hysteresis requires relatively lower mobility to enter the relaxed mode and requires relatively higher observed mobility to exit the relaxed mode.

Accordingly, in some embodiments described herein the WD adapts its RX beam sweeping before obtaining a measurement sample, which may be a time-frequency sample of reference signal measurement by the WD. A sample may also be called as snapshot, signal shot, measurement shot, and so forth. The WD uses one or more measurement samples to obtain or perform one or more measurements during the measurement time. Examples of measurement time are measurement period of a measurement (e.g. RSRP, RSRQ, etc.), cell detection period (e.g. time to acquire physical cell ID of a cell), evaluation period (e.g. for radio link monitoring (RLM) out of sync detection, for RLM in-sync detection, for beam failure detection, for candidate beam detection, for L-RSRP measurement etc.), cell reselection time, and measurement rate indicates how frequent the UE performing the measurements etc.

As mentioned, the RX adaptation parameters, and accordingly the various thresholds mentioned herein, may be predefined, or configured by the network node, and transmitted to the WD. The thresholds may be applied to both serving and neighbor cell beam evaluation.

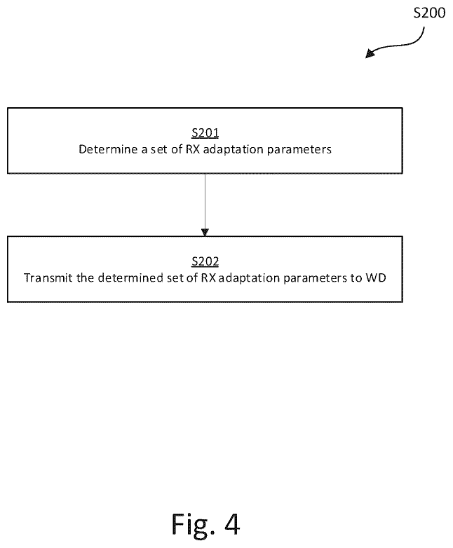

FIG. 4 is a schematic flow chart representation of computer-implemented method S200 performed by a network node for communicating with a WD in a wireless communication system. The method S200 comprises determining S201 a set of RX adaptation parameters indicative of a threshold (H1). The set of RX adaptation parameters is to be used by a WD for determining a RX beam sweeping configuration.

The method S200 further comprises transmitting S202 the determined set of RX adaptation parameters to the WD. In accordance with the above example embodiments, the determined S201 and transmitted S202 RX adaptation parameters may be further indicative of the second threshold (H2), as well as the other parameters and functions described in the foregoing.

Executable instructions 24, 34 for performing these functions are, optionally, included in a non-transitory computer-readable storage medium 23, 33 or other computer program product configured for execution by one or more processors 21, 31.

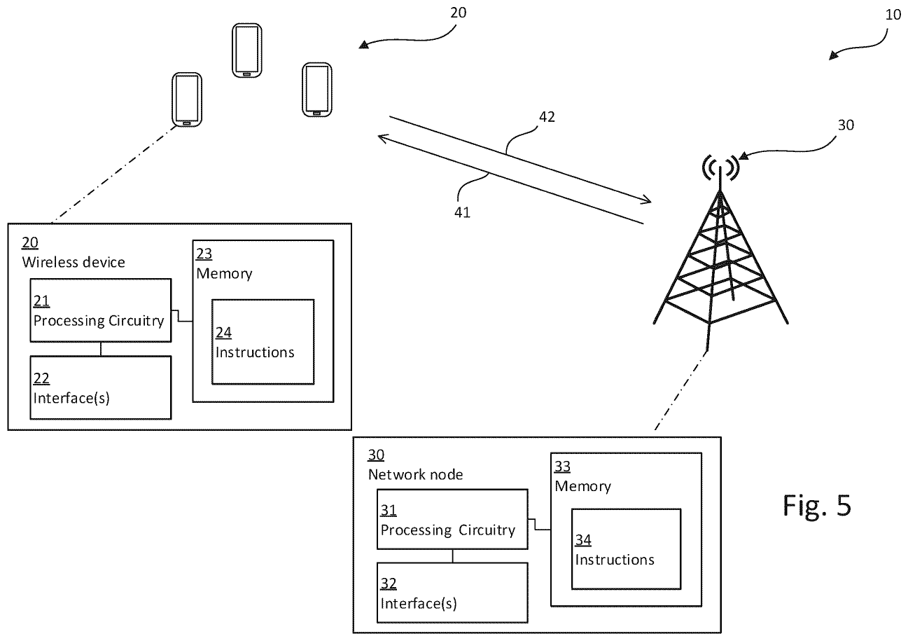

FIG. 5 depicts a wireless communications network 10 in which embodiments herein may operate. In some embodiments, the wireless communications network 10 may be a radio communications network, such as, 5G or NR network. Although, the wireless communications network 10 is exemplified herein as an 5G or NR network, the wireless communications network 10 may also employ technology of any one of LTE, LTE-Advanced, WCDMA, GSM/EDGE, WiMax, UMB, GSM, or any other similar network or system. The wireless communications network 10 may also employ technology of an Ultra Dense Network, UDN, which e.g. may transmit on millimetre-waves (mmW).

The wireless communications network 10 comprises a network node 30. The network node 30 may serve wireless devices in at least one cell, or coverage area. The network node 30 may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 10. Further examples of the network node 30 may be a repeater, multi-standard radio (MSR) radio node such as MSR BS, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), or core network node.

In FIG. 5, three wireless devices 20 are located within the cell. The wireless devices 20 are configured to communicate within the wireless communications network 10 via the network node 30 over a radio link served by the network node 30. Utilizing the radio link, a bi-directional communications flow may be set up between the wireless devices 20 and any entity capable of communication via the wireless communications network 10. The wireless devices 20 may transmit data over an air or radio interface to the radio base station 30 in uplink (UL) transmissions 42 and the radio base station may transmit data over an air or radio interface to the wireless devices 20 in downlink (DL) transmissions 41. The wireless devices 30 may refer to any type of wireless device (WD) or User Equipment (UE) communicating with a network node and/or with another wireless device in a cellular, mobile or radio communication network or system.

Furthermore, the wireless device 20 comprises processing circuitry (may also be referred to as control circuitry, one or more processors) 21, at least one memory 23, and at least one communication interface 22. The computer storage media 23 of the WD 20 may include volatile and non-volatile, removable and non-removable media implemented in any method or technology for storage of information, such as computer readable instructions, data structures, program modules, or other data. The system memory 23 are all examples of (non-transitory) computer-readable storage media. Non-transitory computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the processing circuitry 21. Any such non-transitory computer-readable storage media may be part of the WD 20.

In various embodiments, the memory 23 may store programming instructions 24 which, when executed by the processing circuitry 21, implement some or all of the methods S100 described above. The WD 20 may also be capable of forming communication connections that allow the WD 20 to communicate with other WDs or network nodes via the communication interface 22. The communication interface 23 may comprise a transmitter, a receiver, or a transceiver which are in data communication with other network entities in a telecommunications network 10 and are configured to transmit and receive signals accordingly. The WD may further comprise an antenna arrangement (not shown), such as a directional antenna arrangement, connectable to the processing circuitry 21 via the communication interface 22 so to be able to transmit and receive signals via the antenna arrangement.

In some embodiments, the processing circuitry 21 is configured to obtain a beam timing variability parameter indicative of a change in RX timing for a reference signal (RS) associated with a beam. Furthermore, if the beam timing variability parameter is above a threshold (H1), the control circuitry 21 use an RX beam sweeping configuration in accordance with a first receiver activity pattern. However, if the beam timing variability parameter is below the threshold (H1), the control circuitry 21 is configured to use an RX beam sweeping configuration in accordance with a second receiver activity pattern.

Further, the network node 30 comprises processing circuitry (may also be referred to as control circuitry, one or more processors) 31, at least one memory 33, and at least one communication interface 32. The computer storage media 33 of the network node 30 may include volatile and non-volatile, removable and non-removable media implemented in any method or technology for storage of information, such as computer readable instructions, data structures, program modules, or other data. The system memory 33 are all examples of (non-transitory) computer-readable storage media. Non-transitory computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the processing circuitry 31. Any such non-transitory computer-readable storage media may be part of the WD 30.

In various embodiments, the memory 33 may store programming instructions 34 which, when executed by the processing circuitry 31, implement some or all of the methods S200 described above. The network node 30 may also be capable of forming communication connections that allow the WD 30 to communicate with other WDs or network nodes via the communication interface 32. The communication interface 32 may comprise a transmitter, a receiver, or a transceiver which are in data communication with other network entities in a telecommunications network 10 and are configured to transmit and receive signals accordingly. The network node 30 may further comprise an antenna arrangement (not shown), such as a directional antenna arrangement, connectable to the processing circuitry 31 via the communication interface 33 so to be able to transmit and receive signals via the antenna arrangement.

In some embodiments, the processing circuitry 31 is configured to determine a set of RX adaptation parameters indicative of a threshold (H1), where the set of RX adaptation parameters is to be used by a WD 20 for determining a RX beam sweeping configuration. The processing circuitry 31 is further configured to transmit the determined set of RX adaptation parameters to the WD 20.

In summary, the embodiments disclosed herein may allow for a reduction of the UE beam sweeping activity time so to complete a beam sweep faster. Moreover, the embodiments disclosed herein may allow for a better beam tracking in dynamic environments and/or reduce UE energy consumption associated with beam monitoring and best beam pair tracking.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The processor(s) (associated with the WD 20 or the network node 30) may be or include any number of hardware components for conducting data or signal processing or for executing computer code stored in memory. As mentioned, the WD or the network node may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to some embodiments, any distributed or local memory device may be utilized with the devices and methods of this description. According to some embodiments the memory is communicably connected to the processor (e.g., via a circuit or any other wired, wireless, or network connection) and includes computer code for executing one or more processes described herein.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. All such variations are within the scope of the disclosure. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present disclosure. Other solutions, uses, objectives, and functions within the scope of the disclosure as claimed in the below described patent embodiments should be apparent for the person skilled in the art.

In the drawings and specification, there have been disclosed some example embodiments. However, many variations and modifications can be made to these embodiments. Accordingly, although specific terms are employed, they are used in a generic and descriptive sense only and not for purposes of limitation, the scope of the embodiments being defined by the following claims.

1: A computer-implemented method performed by a wireless device (WD) in a wireless communication system, the method comprising:
obtaining one or more beam timing variability parameters indicative of a change in receiver (RX) timing for a reference signal (RS) associated with an RX beam;
if the beam timing variability parameter is above a threshold, using an RX beam sweeping configuration in accordance with a first receiver activity pattern; and
if the beam timing variability parameter is below the threshold, using an RX beam sweeping configuration in accordance with a second receiver activity pattern,
wherein the RX beam sweeping configuration in accordance with the second receiver activity pattern comprises sweeping a subset of all of the available RX beams of a beam measurement period.

2: The method according to claim 1, wherein obtaining the one or more beam timing variability parameter comprises:
obtaining a set of RX adaptation parameters indicative of a threshold;
determining a reference timing of the reference signal to be received by the WD;
determining a beam timing of the reference signal received by the WD; and
wherein the beam timing variability parameter comprises a beam timing difference indicative of a difference between the determined reference timing and the determined beam timing.

3: The method according to claim 2, wherein the reference timing is determined based on an arrival timing of one or more previous reference signals at the wireless device, and the beam timing is determined based on an arrival timing of a current reference signal at the wireless device.

4: The method according to claim claim 1, wherein the RX beam sweeping configuration in accordance with the first receiver activity pattern comprises a legacy beam sweeping and measurement pattern for RS detection and measurements; and
wherein the RX beam sweeping configuration in accordance with the second receiver activity pattern comprises a more relaxed beam sweeping and measurement pattern for RS detection and measurements as compared to the first receiver activity pattern.

5: The method according to any one of the preceding claims, wherein the RX beam sweeping configuration in accordance with the first receiver activity pattern comprises sweeping all of the available RX beams of a beam measurement period.

6-7. (canceled)

8: The method according to claim 1, wherein the number of RX beams in the subset is dependent on a difference between the beam timing variability parameter and the threshold.

9: The method according to claim 1, wherein the RX beams comprised in the subset is dynamically determined based on a measured signal level metric of the reference signals measured in the RX beams of a previous beam measurement period.

10-20. (canceled)

21: The method according to claim 1, wherein the reference signal is one or more of:
a Primary Synchronization Signal;
a Secondary Synchronization Signal;
a Channel State Information Reference Signal;
a Demodulation Reference Signal;
a Discovery Reference Signal;
a signal in Synchronization signal and Physical Broadcast Channel block;
Cell-Specific Reference Signals; and
Positioning Reference Signals.

22-23. (canceled)

24: A wireless device for communicating with a network node in a wireless communication system, the wireless device comprising processing circuitry configured to:
obtain one or more beam timing variability parameter indicative of a change in receiver (RX) timing for a reference signal (RS) associated with a beam;
if the beam timing variability parameter is above a threshold, use an RX beam sweeping configuration in accordance with a first receiver activity pattern; and
if the beam timing variability parameter is below the threshold, use an RX beam sweeping configuration in accordance with a second receiver activity pattern,
wherein the RX beam sweeping configuration in accordance with the second receiver activity pattern comprises sweeping a subset of all of the available RX beams of a beam measurement period.

25: The wireless device according to claim 24, wherein the control circuitry is configured to obtain the one or more beam timing variability parameter by:
obtaining a set of RX adaptation parameters indicative of a threshold;
determining a reference timing of the reference signal to be received by the WD;
determining a beam timing of the reference signal received by the WD; and
wherein the beam timing variability parameter comprises a beam timing difference indicative of a difference between the determined reference timing and the determined beam timing.

26: The wireless device according to claim 25, wherein the reference timing is determined based on an arrival timing of one or more previous reference signals at the wireless device, and the beam timing is determined based on an arrival timing of a current reference signal at the wireless device.

27: The wireless device according to claim 24, wherein the RX beam sweeping configuration in accordance with the first receiver activity pattern comprises a legacy beam sweeping and measurement pattern for RS detection and measurements; and
wherein the RX beam sweeping configuration in accordance with the second receiver activity pattern comprises a more relaxed beam sweeping and measurement pattern for RS detection and measurements as compared to the first receiver activity pattern.

28: The wireless device according to claim 24, wherein the RX beam sweeping configuration in accordance with the first receiver activity pattern comprises sweeping all of the available RX beams of a beam measurement period.

29-30. (canceled)

31: The wireless device according to claim 24, wherein the number of RX beams in the subset is dependent on a difference between the beam timing variability parameter and the threshold.

32: The wireless device according to claim 24, wherein the RX beams comprised in the subset is dynamically determined based on a measured signal level metric of the reference signals measured in the RX beams of a previous beam measurement period.

33-47. (canceled)
